(19) United States
(12) Patent Application Publication
(10) Pub. No.: US 2025/0199495 A1
(43) Pub. Date: Jun. 19, 2025

(54) Automation Device with Improved Energy Supply System, Method for Operating the Automation Device, Control Unit and Computer Program Product

(71) Applicant: Siemens Aktiengesellschaft, Muenchen (DE)

(72) Inventors: Eric CHEMISKY, Wissembourg (FR); Frank PROBST, Herxheim bei Landau/Pfalz (DE)

(21) Appl. No.: 18/848,945

(22) PCT Filed: Mar. 17, 2023
(86) PCT No.: PCT/EP2023/056874

§ 371 Date: Sep. 20, 2024

(30) Foreign Application Priority Data
Mar. 21, 2022 (DE) 10 2022 202 748.5

(51) Int. Cl. G05B 17/02; H02J 7/00

(52) U.S. Cl. CPC G05B 17/02; H02J 7/00714; H02J 7/007192

(57) ABSTRACT

An automation device, a method for operating the automation device, a control unit and a computer program product for simulating the operational behavior of the automation device, wherein the automation device includes application electronics, a communication unit and an energy supply system for operating the application electronics and the communication unit, where the energy supply system has a battery and a capacitor that are connected together via a switch that can be actuated by a control unit, and where the battery is a lithium thionyl chloride battery.

### CROSS-REFERENCE TO RELATED APPLICATIONS

This is a U.S. national stage of application No. PCT/EP2023/056874 filed 17 Mar. 2023. Priority is claimed on German Application No. 10 2022 202 748.5 filed 21 Mar. 2022, the content of which is incorporated herein by reference in its entirety.

### BACKGROUND OF THE INVENTION

### 1. Field of the Invention

The invention relates to an automation device having an improved energy supply system, an operating method for the automation device, a correspondingly configured control unit and to a computer program product for simulating the operating behavior of the automation device.

### 2. Description of the Related Art

U.S. Pat. No. 9,627,908 B2 discloses a battery-capacitor arrangement that can be used in a motor vehicle. The battery-capacitor arrangement has a charge controller as a way to activate switches so that the capacitor can be connected to the battery. In particular, the battery can be recharged via the capacitor.

The data sheet for the LS 14500 battery from SAFT America Inc., document number 31064-2-0821, discloses technical information concerning a lithium-thionyl chloride battery. In particular, the data sheet details different temperature-dependent operating characteristics of such batteries, which are not rechargeable.

In automation technology, an increasing number of automation devices of different types are being used to measure, influence or handle various process variables, e.g., in a plant process. Battery-operated automation devices are used inter alia for this purpose. Reliable and cost-efficient operation therefore requires batteries that are long-lasting and at the same time cost-effective. Increasing demands are also being placed on the compactness of such automation devices.

### SUMMARY OF THE INVENTION

It is an object of the invention to provide an automation device having an improved energy supply system, an operating method for the automation device, a correspondingly configured control unit and a computer program product for simulating the operating behavior of the automation device that deliver an improvement in at least one of the aspects described.

This and other objects and advantages are achieved in accordance with the invention by an automation device in accordance with the invention. The automation device can be formed as a sensor, actuator or data processing unit. In particular, the automation device can be formed as an industrial automation device. The automation device comprises application electronics, e.g., a measuring apparatus, via which a variable to be measured can be detected and converted into a measurement signal if the automation device is formed as a sensor. The application electronics can also be configured as an actuating apparatus that can be used to act upon a measured variable if the automation device is formed as an actuator, or as a computing unit that can be used to process measurement signals if the automation device is configured as a data processing unit. The automation device also comprises a communication unit that allows data to be exchanged with an evaluation unit to which the automation device can be linked. The automation device also comprises an energy supply system via which electrical energy can be provided and which is configured to operate the application electronics and the communication unit. The energy supply system comprises a battery and a capacitor that interact to supply the communication unit and/or the application electronics with electrical energy. The battery and the capacitor can be interconnected in an electrically conductive manner via a switch. The switch can be actuated via a control unit that is also part of the automation device. For example, by activation of the switch, the capacitor can be charged from the battery and/or battery-assisted operation of the automation device can be supported by the capacitor. In accordance with the invention, the battery of the energy supply system is configured as a lithium-thionyl chloride battery or as a rechargeable battery. The amperage required for most of the operation of the automation device is relatively low. The lithium-thionyl chloride battery has an increased usable energy content at low current intensities, e.g., below 30 mA. In particular, the lithium-thionyl chloride battery in the automation device in accordance with the invention has a service life of at least five years. The switch that can be actuated via the control unit enables the operation of the lithium-thionyl chloride battery to be matched to changing ambient conditions and/or power requirements. The automation device in accordance with the invention can function with a reduced number of simple components and is therefore cost-efficient.

In one embodiment of the automation device, the control unit is configured to minimize the operating current at the battery during operation of the automation device by actuating the switch. The operating current is to be understood as being the amperage produced by the battery when the automation device is in an operating state, e.g., during pulsed operation of the communication unit. The lower the temperature of the battery, the lower its performance, e.g., its maximum available energy content. The capacitor, on the other hand, is largely insensitive to temperature with respect to the operating current that can be provided, in particular a pulse current. However, the higher the temperature of the capacitor, the higher the leakage current. The switch allows the capacitor and the battery to be combined using their corresponding complementary properties. As a result of the minimized operating current, actuating the switch therefore serves to extend the service life of the battery.

In addition, in the inventive automation device, the control unit can be connected to a temperature sensor. The temperature sensor can be configured to detect battery temperature, control unit temperature and/or ambient temperature. The temperature sensor can be formed separately and can be connectable to the control unit, or can be incorporated in the control unit. The control unit can also be configured for temperature-dependent actuation of the switch. Accordingly, the capacitor is connected to or disconnected from the battery by the switch depending on the temperature. The temperature sensor can have a measurement tolerance of at least +/−5° C. The invention is based, among other things, on the surprising realization that particularly long-life operation of the automation device can be achieved using the battery, even with such a reduced measurement accuracy. The technical potential of the battery can thus be exploited to a greater extent. Conversely, overdimensioning, e.g., by providing a plurality of batteries in order to achieve the required service life, can be avoided. The inventive automation device thus offers a high degree of compactness in addition to the extended achievable service life.

In addition, the capacitor for operating the communication unit can be brought into circuit via the switch. The communication unit has an increased energy requirement when in active operation, e.g., in transmit mode. By bringing the capacitor into circuit, it can be used to support the battery during active operation of the communication unit. The amperage at the battery during this time can thus be reduced. High-load operation, which has a detrimental effect on the service life of the battery, is therefore reduced. Alternatively or additionally, the control unit in the inventive automation device can be permanently supplied by the battery. When in active operation, the control unit has a reduced energy requirement that can easily be covered by the battery even at low temperatures. The capacitor can therefore be brought into circuit specifically for the operation of the communication unit and/or of the application electronics. This means that the technical advantages of the inventive automation device as outlined above are specifically achievable.

Moreover, the control unit in the inventive automation device can be configured for time-controlled or event-controlled actuation of the switch. In the case of time-controlled actuation, the switch is set to switching or blocking for a predetermined duration. Time-controlled actuation is easy to perform and makes it possible to predict the power consumption, i.e., the amperage and corresponding duration, at the battery. Accordingly, the discharging behavior of the battery can be simulated in a simple yet precise manner. This in turn makes it possible to predict a maintenance time at which the battery needs to be replaced. The predicting of the maintenance time can therefore be performed independently of the automation device itself, e.g., via an evaluation unit that can be communicatively linked to the communication unit of the automation device. The event-controlled actuation of the switch can be established such that the capacitor is brought into circuit by the control unit for as long as the communication unit and/or the application electronics are in active operation. This enables discharging of the capacitor to be minimized, which in turn reduces the capacitor charging time after active operation. As a result, the electrical energy stored in the energy supply system is used particularly efficiently.

In a further embodiment of the automation device, the capacitor has a leakage current of up to 3 μA, in particular up to 1 μA, at a temperature of up to 20° C. For this purpose, the capacitor can be formed as a super-cap, hybrid super-cap or ultra-cap, for example. At such temperatures, the lithium-thionyl chloride battery has a reduced energy content, particularly in pulsed mode. The capacitor can be connected to the battery at an appropriate temperature by actuating the switch. The losses due to the leakage current are minimized at the same time. Overall, this results in an improved storage effect. Alternatively or in addition, the battery can have a capacity, i.e., an energy content, of at least 2 Ah at a temperature of 55° C. and be established to provide an amperage of at least 100 mA. At such temperatures, the capacitor has an increased leakage current and can be disconnected from the battery by the switch. Overall, this provides sufficient electrical energy for intermittent operation of the automation device over an increased battery lifetime, e.g., of at least five years.

The switch in the inventive automation device can also be configured as a field-effect transistor, in particular as a MOSFET, or as a bistable relay. Field-effect transistors are compact and offer a reliable blocking effect at elevated electrical voltages. The control unit in the inventive automation device also can be configured as a microcontroller. Microcontrollers can be configured to be programmable and offer a wide range of adjustable control functions with minimized energy requirements. Alternatively or additionally, the communication unit can be configured as a radio communication unit, e.g., as a WLAN, Bluetooth, ZigBee, LoRaWAN or mobile radio unit, in particular as a 5G unit. This eliminates the wiring complexity required for connecting the automation device to an evaluation unit. The automation device can therefore be implemented quickly and easily as part of a retrofit to an existing plant. Similarly, the energy-saving operation that can be achieved with the inventive automation device means that an increased service life can be delivered. This makes sensors with wireless communication units a practical option or at least more cost-efficient in a large number of applications.

In addition, the inventive automation device can be supplied with electrical energy solely by the energy supply system. Accordingly, there is no connection, in particular no wired connection, to the power grid. The automation device is thus operated exclusively via the electrical energy electrochemically stored in the battery, i.e., its energy content. The energy supply system can be miniaturized to a greater extent, so that the inventive automation device is particularly compact overall. The inventive automation device can therefore also be installed in locations with reduced installation space, in particular in an existing plant. Moreover, the energy supply system comprises simple and reliable components that permit long-lasting and robust operation. The energy supply system can also be easily encapsulated, i.e., shielded against penetrating gases or gas mixtures. An encapsulated energy supply system means that the automation device in question can also be used safely in environments where flammable or explosive gases or gas mixtures are present. Alternatively or additionally, the energy supply system of the automation device can be connected to a fluctuating external energy source which can be formed as a photovoltaic cell or wind turbine. The capacitor can be charged by the fluctuating external energy source. A battery configured to be rechargeable can also be recharged by the fluctuating external energy source.

In a further embodiment of the automation device, which is formed as a sensor, the measuring apparatus can comprise, as application electronics, a radar emitter, a lidar emitter, an ultrasonic emitter, a tuned-diode laser, a smoke detector and/or infrared analytics. Such measuring apparatuses have an increased energy requirement in active operation. The energy requirement of such measuring apparatuses can be supported by the capacitor. This avoids increased amperage at the battery. Such energy-intensive measuring apparatuses can be operated in pulsed mode in the automation device under load without significantly impairing the service life of the battery. In particular, the battery can be operated for longer at a design point for increased service life or energy content.

Alternatively or additionally, the measuring apparatus can have an interface that can be operated with 4 mA to 20 mA. The automation device in accordance with the contemplated embodiments can thus implement a large number of measuring principles with increased service life. Consequently, the inventive automation device is readily adaptable to a variety of applications.

The objects and advantages are also achieved in accordance with the invention by for operating an automation device. The automation device comprises application electronics, a communication unit and an energy supply system for operating the application electronics. The energy supply system has a battery and a capacitor that are interconnected via a switch. The connection via the switch can be interrupted and/or closed by actuating the switch. The method comprises a first step in which the automation device is deployed in an operating state in which the capacitor is at least partially charged. Likewise, all the components of the automation device are functional in this operating state. This is followed by a second step in which a temperature is detected and the switch is closed. The switch is closed when the automation device is in idle mode, i.e. when the application electronics are not actively operating and/or the communication apparatus is not transmitting. The switch is also closed if the temperature detected in the second step is below a threshold temperature. Alternatively, the switch is opened when the temperature detected in the second step exceeds the threshold temperature. The threshold temperature thus defines the temperature at which the capacitor is connected in circuit to support the battery in idle mode. At low temperatures, this makes it possible to reduce battery operation that is detrimental to service life. Conversely, at higher temperatures, operation with losses due to leakage currents at the capacitor can be reduced. The temperature detected in the second step can be a battery, control unit and/or ambient temperature.

Alternatively or in addition to the second step, a third step is performed in accordance with the method of the invention. In the third step, the switch is closed to support active operation of the automation device in which the communication unit and/or the application electronics are operated. In particular, when the switch is closed, electrical energy is provided via the capacitor to operate the communication unit or the application electronics. As a result, heavy-load operation of the battery is reduced by the electrical energy provided by the capacitor.

The communication unit of the automation device is configured as a radio communication unit, e.g., as a WLAN, Bluetooth, ZigBee, LoRaWAN or mobile radio unit, in particular as a 5G unit. The method in accordance with the invention minimizes the operating current during operation of the automation device, thereby increasing the service life of the battery. In addition, the load on the battery during active operation is reduced, which also results in an increased service life of the battery. The method in accordance with the invention thus makes it possible to operate an automation device with a radio communication unit using a battery of reduced dimensions and, by making greater use of this battery, to extend the time to maintenance when the battery needs to be replaced. The method requires a minimum of simple components and can be implemented cost-effectively. Automation devices with radio communication units are thus suitable for a wide range of practical applications, particularly in plant automation.

In accordance with one embodiment of the method, the automation device can be claimed in accordance with at least one of the above-disclosed embodiments. The technical features of the inventive automation device are therefore analogously transferable to the method and the technical features of the method are transferable to the inventive automation device. The technical advantages of the inventive automation device thus also apply equally to the inventive method.

In addition, the third step of the method can be performed in a time-controlled or event-controlled manner. Time-controlled means that the switch is set to switching or blocking for a predetermined duration. Time-controlled closing is easy to implement and makes it possible to predict power consumption, i.e., the amperage and corresponding duration, at the battery. Accordingly, the discharging behavior of the battery can be simulated in a simple yet precise manner. This in turn makes it possible to predict a maintenance time at which the battery needs to be replaced. The maintenance time can therefore be predicted independently of the automation device itself, e.g., via an evaluation unit that can be communicatively linked to the communication unit of the automation device. The event-controlled closing of the switch can be established so that the capacitor is connected in circuit by the control unit for as long as the communication unit and/or the measuring apparatus are active. This makes it possible to minimize the discharging of the capacitor, which in turn reduces the capacitor charging time required following active operation.

The objects and advantages are further achieved in accordance with the invention by an inventive control unit which is configured to operate an automation device. The control unit comprises a memory and a computing unit, which are configured to store and execute instructions, respectively. The control unit is also configured to receive measurement signals that can be generated during active operation by application electronics, e.g., a measuring apparatus, of the automation device. Similarly, the control unit is configured to issue control commands with which a switch in the automation device can be actuated. In accordance with the invention, the control unit is suitable for implementing at least one method in accordance with the above-outlined embodiments. Accordingly, the features of the inventive method and the inventive automation device are transferable to the control unit in accordance with the invention. To implement the inventive method, the control unit can have a corresponding program.

In particular, the control unit can be configured as a microcontroller that is disposed in the automation device.

The objects and advantages are also achieved in accordance with the invention by an inventive computer program product for simulating the operational behavior of an automation device. For this purpose, the computer program product has a physics module that is configured at least to simulate an energy consumption of the automation device. The physics module can also be configured to replicate a behavior of the control unit, i.e., the reception of measurement signals and the issuance of control commands. For this purpose, the computer program product in accordance with the invention comprises a digital image of at least one energy supply system of the automation device to be simulated, which replicates, for example, its structural design and/or its mode of operation. Alternatively or additionally, the energy supply system can also be configured as a computer model in the physics module. The physics module is configured to replicate the operational behavior of the automation device under adjustable operating conditions. The adjustable operating conditions include, for example, a duration and frequency of active operation, i.e., a measuring operation of a measuring apparatus and/or a transmitting operation of a communication unit, a temperature profile of the environment, thermal properties of a battery of the energy supply system, a probability distribution for an operating time in a particular temperature range, a control behavior of a control unit, an electrical load profile by the measuring apparatus or the communication unit, and/or a switching behavior of a switch. An achievable service life of the battery, i.e., of the automation device, can thus be predicted. In particular, an upcoming maintenance operation, such as replacing the battery, can be predicted more accurately. The computer program product can have a data interface via which corresponding data can be preset via a user input and/or other simulation-oriented computer programs. The computer program product can also have a data interface for outputting simulation results to a user and/or other simulation-oriented computer program products. With the computer program product, for example, the plausibility of a measured charge level of the battery can be checked by simulation. The inventive computer program product is also configured to provide fault diagnostics for an automation device in accordance with the disclosed embodiments of the invention. In addition, the computer program product can be executed at least partially during ongoing operation on the inventive automation device to predict maintenance procedures and/or for fault signaling.

The underlying automation device whose operating behavior can be simulated by the computer program product in accordance with the invention is made up of simple components.

Consequently, it can be simulated algebraically, i.e., without recourse to finite element methods. Accordingly, the computer program product in accordance with the invention can be executed sufficiently quickly even with reduced computing power. In particular, the computer program product in accordance with the invention can provide real-time capability, e.g., for real-time monitoring of a simulated automation device. Further requirements that define the real-time capability arise, for example, from a plant process in which the automation device can be incorporated. In addition, the computer program product in accordance with the invention can also be used to monitor a plurality of automation devices in a practicable manner as part of a plant process. The computer program product can be formed as a “digital twin”, as described, e.g., in US Pub. No. 2017/286572 A1, the content of which is incorporated herein by reference in its entirety. The computer program product can be of monolithic design, i.e., it can be executed entirely on one hardware platform. Alternatively, the computer program product can be modular and comprise a plurality of subprograms that can be executed on separate hardware platforms and that interact via a data communication link, e.g., a computer cloud and/or a host computer. Such a data communication link can be a network connection or an Internet connection. The computer program product in accordance with the invention can also be used to test and/or optimize an automation device by simulation.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be explained in more detail with reference to individual embodiments illustrated in accompanying figures. The figures are to be viewed as complementary to one another in that the same reference characters in different figures have the same technical meaning. The features of the individual embodiments can also be combined with one another. In addition, the embodiments shown in the figures can be combined with the features outlined above, in which:

FIG. 1 schematically illustrates a sensor system with a first embodiment of the sensor in accordance with the invention;

FIG. 2 schematically illustrates a sensor system with a second embodiment of the sensor in accordance with the invention; and

FIG. 3 schematically illustrates a sequence of an embodiment of the method in accordance with the invention.

### DETAILED DESCRIPTION OF THE EXEMPLARY EMBODIMENTS

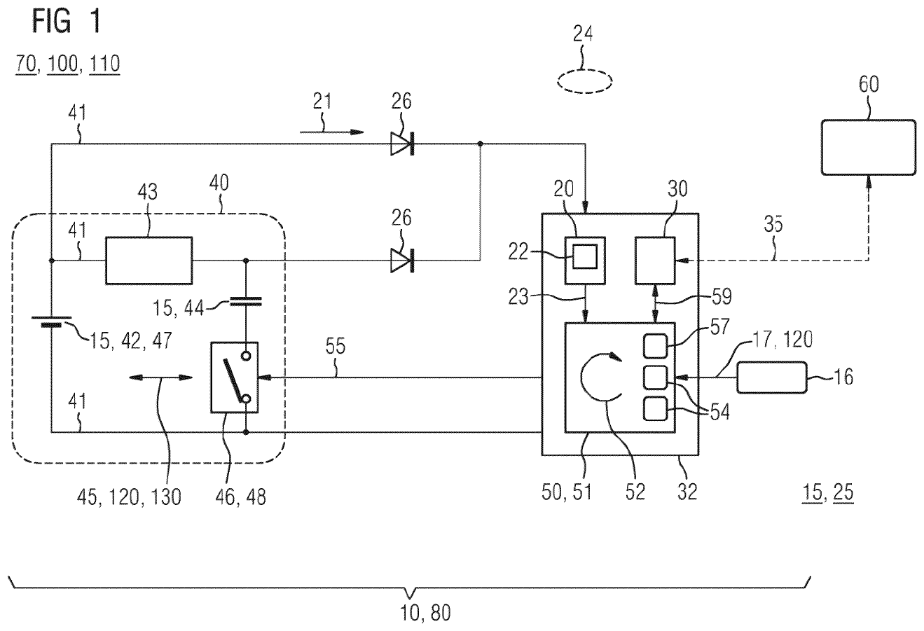

FIG. 1 shows an automation system 70 that is provided with an automation device 10 in accordance with a first embodiment of the invention and thatcan be configured as a sensor. The automation system 10 comprises application electronics 20 that can be configured as a measuring apparatus and that can have a radar emitter 22. The application electronics 20 can detect a measured variable 24 that is present in an environment 25 of the sensor 10 and with respect to which corresponding measurement signals 23 can be generated. The measurement signals 23 are generated during active operation of the automation device 10 and are transmitted to a control unit 50 that is formed as a microcontroller 51. To operate the automation device 10, the control unit 50 is equipped with a program 52 that is configured to receive and process the measurement signals 23. In addition, the sensor 10 has a communication unit 30 that is connected to the control unit 50 via a data communication link 59. The communication unit 30 is configured to establish a data communication link 35 with an evaluation unit 60 which, together with the automation device 10, forms part of an automation system 70. The application electronics 20, the communication unit 30 and the control unit 50 constitute, at least functionally, a load system 32. The automation device 10 also has an energy supply system 40 that is connected via electrical lines 41 to the load system 32, i.e., the measuring apparatus 20, the communication unit 30 and the control unit 50. The energy supply system 40 is configured to provide electrical energy for the latter over a period of use. The energy supply system 40 comprises a battery 42 designed as a lithium-thionyl chloride battery 47. The battery 42 is in turn connected to a capacitor 44 via electrical lines 41 and a current-limiting element 43. Diode-like components 26 are disposed on the lines 41 to prevent current peaks from affecting the battery 42. In addition, a switch 46 formed as a field-effect transistor 48 is mounted between the capacitor 44 and the battery 42. The switch 46 can be actuated via control commands 55 that can be issued by the control unit 50.

During intended operation of the automation device 10, a method 100 can be implemented in which, in a first step 110, the automation device 10 is deployed in an operating state in which the capacitor 46 is at least partially charged. Such an operating state is present in FIG. 1. In a second step 120, a temperature 15 is then detected by a temperature sensor 16 connected to the control unit 50. The temperature sensor 16 is configured to detect a temperature 15 of the environment 25, of the battery 42 and/or of the capacitor 44. The detected temperature 15 is transmitted to the control unit 50 as a measured temperature value 17. In the second step 120, the switch 46 is then actuated 45. The switch 46 is closed in the second step 120 via a control command 55 if the detected temperature 15 is below a threshold temperature 57. As a result, electrical energy is provided by the capacitor 44 to support the operation of the automation device 10, i.e., of at least one component of the load system 32. High-load and therefore degradative operation of the battery 42 at a low temperature 15 is thus minimized. Conversely, in the second step 120, the switch 46 is opened via a control command 55 if the detected temperature 15 exceeds the threshold temperature 57. As a result, the battery 42 can be operated in a low-degradation state. Overall, an operating current 21, i.e., an amperage, is thus provided by the energy supply system 40 in pulsed operation of the application electronics 20, the communication unit 40 and the control unit 50. Pulsed operation is to be understood as meaning the absence of active operation of the application electronics 20 and the communication unit 30. The threshold temperature 57 is stored in the control unit 50. The threshold temperature 57 can be specified by a user input, the evaluation unit 60, or determined automatically by the control unit 50. For this purpose, the control unit 50 can be provided with data 54 with respect to the battery 42, the capacitor 44 and/or the control unit 50 itself. In addition, the data 54 can also include a predicted temperature profile of the environment 25. The threshold temperature 57 can be optimized with regard to a maximum service life of the battery 42, and thus of the automation device 10. The service life is to be understood here as the time until a necessary or at least advisable replacement of the battery 42.

Alternatively or in addition to the second step 120, a third step 130 can be performed as part of the method 100. The required amperage increases due to the onset of active operation of the measuring apparatus 20 and/or of the communication unit 40. In the third step 130, if such active operation is present, then the switch 46 is closed via a control command 55. As a result, electrical energy is provided by the capacitor 44 to support the operation of the measuring apparatus 20 and/or the communication unit 40. The amperage to be provided by the battery 42 is thereby reduced. This also prevents a degradative operating state of the battery 42. The automation device 10 is configured to implement such a method 100 so that a service life of at least five years is achieved for the battery 42. The operating behavior of the automation device 10 can be simulated by a computer program product 80 that comprises a digital image of at least the energy supply system 40. The operating behavior includes, for example, a charge level of the battery 42, a charge level of the capacitor 44 and/or an amperage of the operating current 21. The computer program product 80 is configured as a “digital twin” and can be suitably configured to detect a defective component of the automation device 10. The computer program product 80 can, for example, be executed on the evaluation unit 60, in particular concomitantly with the method 100.

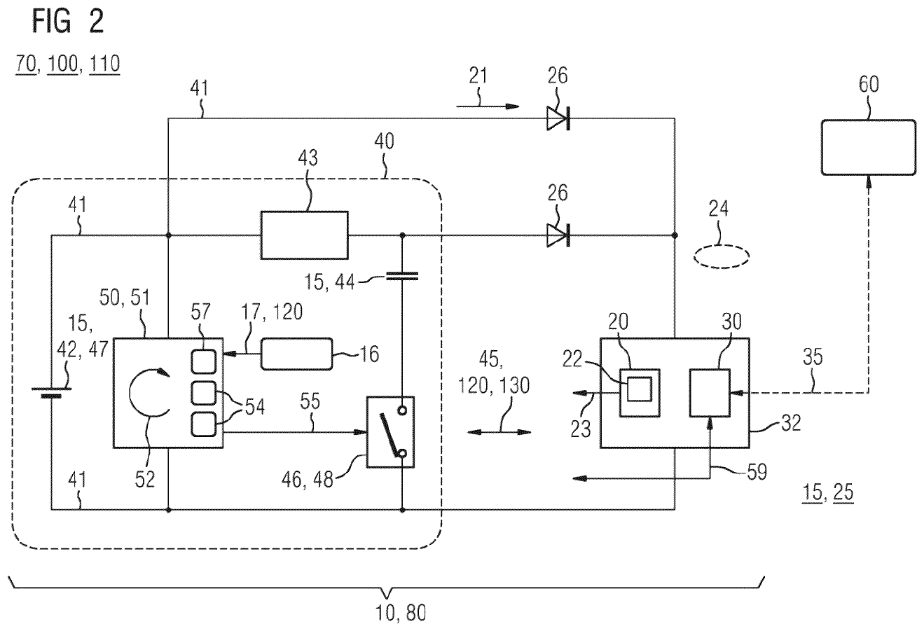

FIG. 2 schematically illustrates an automation system 70 comprising an automation device 10 in accordance with a second embodiment of the invention, where the automation device 10 can be formed as a sensor. The automation device 10 comprises application electronics 20 that can be configured as a measuring apparatus that can have a radar emitter 22. The application electronics 20 can detect a measured variable 24 present in an environment 25 of the automation device 10, with respect to which corresponding measurement signals 23 can be generated. The measurement signals 23 are generated during active operation of the automation device 10 and are transmitted to a control unit 50 configured as a microcontroller 51. To operate the automation device 10, the control unit 50 is equipped with a program 52 that is configured to receive and process the measurement signals 23. In addition, the automation device 10 has a communication unit 30 that is connected to the control unit 50 via a data communication link 59. The communication unit 30 is configured to establish a data communication link 35 with an evaluation unit 60 which, together with the automation device 10, forms part of an automation system 70. The application electronics 20 and the communication unit 30 constitute, at least functionally, a load system 32.

The automation device 10 also has an energy supply system 40 which is connected to the load system 32, i.e., the application electronics 20 and the communication unit 30, via electrical lines 41. Diode-like components 26 are disposed on the lines 41 to prevent current peaks from affecting the battery 42. The energy supply system 40 is configured to provide electrical energy for the latter over a service life. The energy supply system 40 comprises the control unit 50 and a battery 42 formed as a lithium-thionyl chloride battery 47. The control unit 50 is permanently supplied with electrical energy by the battery 42. The battery 42 is also connected to a capacitor 44 via electrical lines 41 and a current-limiting element 43. In addition, a switch 46 formed as a field-effect transistor 48 is provided between the capacitor 44 and the battery 42. The switch 46 can be actuated via control commands 55 which can be issued by the control unit 50.

During intended operation of the automation device 10, a method 100 can be implemented in which, in a first step 110, the automation device 10 is deployed in an operating state in which the capacitor 46 is at least partially charged. Such an operating state is present in FIG. 2. In a second step 120, a temperature 15 is then detected by a temperature sensor 16 that is connected to the control unit 50. The temperature sensor 16 is configured to detect a temperature 15 of the environment 25, of the battery 42 and/or of the capacitor 44. The detected temperature 15 is transmitted to the control unit 50 as a measured temperature value 17. In the second step 120, the switch 46 is then actuated 45. The switch 46 is closed in the second step 120 via a control command 55 if the detected temperature 15 is below a threshold temperature 57. As a result, electrical energy is provided by the capacitor 44 to support the operation of the automation device 10, i.e., of at least one component of the load system 32. High-load and thus degradative operation of the battery 42 at a low temperature 15 is thus minimized. Conversely, in the second step 120, the switch 46 is opened via a control command 55 if the detected temperature 15 exceeds the threshold temperature 57. As a result, the battery 42 can be operated in a low-degradation state. Overall, an operating current 21, i.e., an amperage, is thus provided by the energy supply system 40 during pulsed operation of the application electronics 20, communication unit 40 and control unit 50. Pulsed operation is to be understood as meaning the absence of active operation of the application electronics 20 and the communication unit 30. The threshold temperature 57 is stored in the control unit 50. The threshold temperature 57 can be specified by a user input, the evaluation unit 60, or determined automatically by the control unit 50. For this purpose, the control unit 50 can be provided with data 54 with respect to the battery 42, the capacitor 44 and/or the control unit 50 itself. In addition, the data 54 can also include a predicted temperature profile of the environment 25. The threshold temperature 57 can be optimized with respect to a maximum service life of the battery 42, and thus of the automation device 10. The service life is to be understood here as the time until a necessary or at least advisable replacement of the battery 42.

Alternatively or in addition to the second step 120, a third step 130 can be performed as part of the method 100. The amperage required increases due to the onset of active operation of the measuring apparatus 20 and/or the communication unit 40. In the third step 130, if such active operation is present, then the switch 46 is closed via a control command 55. As a result, electrical energy is provided by the capacitor 44 to support the operation of the measuring apparatus 20 and/or the communication unit 40. The amperage to be provided by the battery 42 is thereby reduced. This also prevents a degradative operating state of the battery 42. The automation device 10 is configured to implement such a method 100 so that a service life of at least five years is achieved for the battery 42. The operating behavior of the automation device 10 can be simulated by a computer program product 80 that comprises a digital image of at least the energy supply system 40. The operating behavior includes, for example, a charge level of the battery 42, a charge level of the capacitor 44 and/or an amperage of the operating current 21. The computer program product 80 is formed as a “digital twin” and can be suitably configured to detect a defective component of the automation device 10. The computer program product 80 can be executed, e.g., on the evaluation unit 60, in particular concomitantly with the method 100.

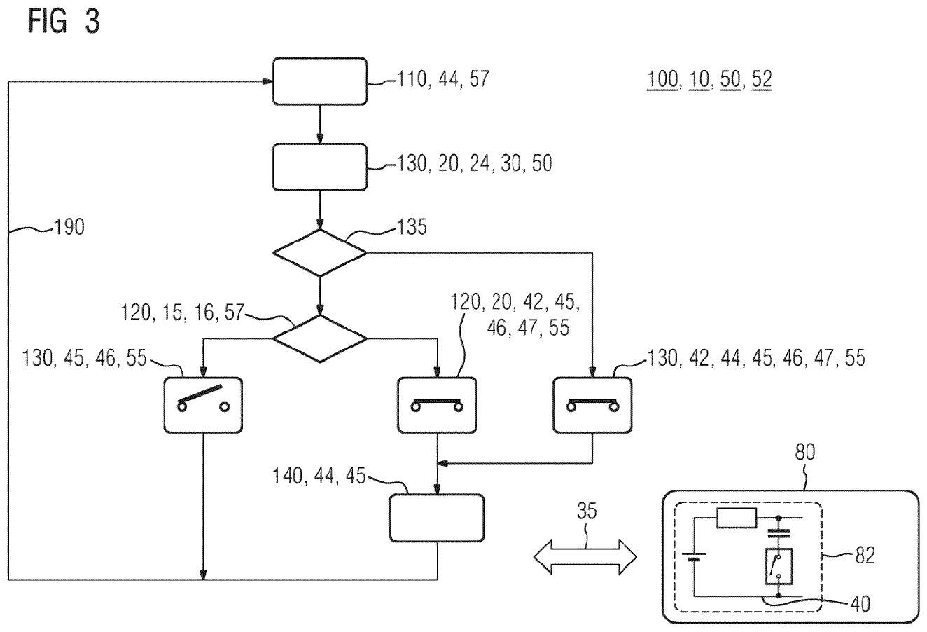

FIG. 3 schematically illustrates a sequence of an embodiment of the method 100 that can be implemented via a program 52 in a control unit 50 of a sensor 10. The automation device 10 can be formed, for example, as in FIG. 1 or FIG. 2. The method 100 proceeds from a first step 110 in which the sensor 57 is deployed in a functional operating state in which a capacitor 44 associated with the automation device 10 is at least partially charged. The control unit 50 is also parameterized in the first step 110. The parameterization of the control unit 50 includes storing a threshold temperature 57 in the control unit 50.

The first step 110 is followed by a third step 130 in which the control unit 50 detects whether the automation device 10 is currently active or about to become active. Active operation means that the application electronics 20 of the automation device 10 are being operated, for example, to detect a measured variable 24. Alternatively or additionally, active operation can refer to a transmit mode of a communication unit 30 of the automation device 10. Accordingly, a branching point 135 occurs in the method 100. If the automation device 10 is active or about to become active, then the method 100 continues with actuation 45 of a switch 46, as illustrated on the right-hand side in FIG. 3. If the automation device 10 is actively operating, then the switch 46 is closed by a control command 55 from the control unit 50, so that the operation of the communication unit 30 and/or of the measuring apparatus 20 is supported by the capacitor 44. In particular, a battery 42 formed as a lithium-thionyl chloride battery 47 is supported, which can be connected to the battery 42 via the switch 46. Subsequent to the active operation of the automation device 10, a fourth step 140 follows in which the capacitor 44 is recharged. If the state of charge of the capacitor 44 is sufficient, then the switch 46 is re-opened by actuating 45 in order to maintain the current state of charge.

In the event that the automation device 10 is not actively operating or no active operation of the automation device 10 is imminent, at the branching point 135 the method 100 follows a different path in which a second step 120 is performed. In the second step 120, a temperature 15 that is relevant for operation of the battery 42 is detected by a temperature sensor 16. In addition, in the second step 120, a comparison with the threshold temperature 57 is performed, leading to a branching point 125 of the method 100 in the second step 120. If the detected temperature 15 is higher than the threshold temperature 57, then the switch 46 is actuated 45 via a control command 55 from the control unit 50, thereby opening the switch 46. This is shown on the left-hand side in FIG. 3. If the switch 46 is already open, then the corresponding control command 55 for opening the switch 46 has no effect, so that the current position of the switch 46 remains unchanged. Since the temperature 15 is above the threshold temperature 57, low-degradation operation of the battery 42 is possible in the case outlined. The battery 42 does not need to be supported by the capacitor 44.

If the temperature 15 detected in the second step 120 is lower than the threshold temperature 57, the switch 46 is closed. A control command 55 is issued by the control unit 50 to actuate 45 the switch 46. The operation of the battery 42 is supported by the closed switch 46. At a temperature 15 that is lower than the threshold temperature 57, the operation of the battery 42 is more degradative the higher the amperage to be provided by the battery 42, i.e., an operating current 21. By closing the switch 46, the capacitor 44 is connected to the battery 42 in an appropriate manner. Accordingly, the capacitor 44 is discharged, thereby supporting the battery 42. This is followed by the fourth step 140 of the method 100, in which the capacitor 44 is recharged. The fourth step 140 can be performed in a coordinated manner having regard to planned subsequent operation. After the fourth step 140 or the third step 140, a return 190 occurs, in which the method 100 returns to the first step 110. Concomitantly with the method 100, a computer program product 80 is executed that is connected to the control unit 50 via a data communication link 35. The computer program product 80 is a “digital twin” and is configured to simulate the operating behavior of the sensor 10 during the method 100. For this purpose, the computer program product 80 comprises a digital image 82 of at least one energy supply system 40 of the sensor 10. The computer program product 80 can be executed with reduced computing power and allows real-time monitoring of the sensor 10.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. An automation device, comprising:
application electronics;
a communication unit; and
an energy supply system for operating the application electronics and the communication unit, said energy supply system comprising a battery and a capacitor;
wherein the battery and the capacitor are interconnectable via a switch which is actuatable via a control unit;
wherein the battery comprises a lithium-thionyl chloride battery;
wherein the automation device is configured to:
a) enter an operating state in which the capacitor is at least partially charged;
b) detect a temperature and close the switch in an idle mode if the temperature is below a threshold temperature or open the switch in the idle mode if the temperature exceeds the threshold temperature; and
c) close the switch to support operation of at least one of (i) the communication unit and (ii) the application electronics when actively operating;
wherein the communication unit is configured as a radio communication unit.

16. The automation device as claimed in claim 15, wherein the control unit is configured to actuate the switch to minimize an operating current at the battery.

17. The automation device as claimed in claim 15, wherein the control unit is connected to a temperature sensor and is configured to actuate the switch in a temperature-dependent manner.

18. The automation device as claimed in claim 16, wherein the control unit is connected to a temperature sensor and is configured to actuate the switch in a temperature-dependent manner.

19. The automation device as claimed in claim 15, wherein at least one of (i) the capacitor for operating the communication unit is connectable in circuit via at least one of the switch and (ii) the control unit is permanently supplied by the battery.

20. The automation device as claimed in claim 16, wherein at least one of (i) the capacitor for operating the communication unit is connectable in circuit via at least one of the switch and (ii) the control unit is permanently supplied by the battery.

21. The automation device as claimed in claim 17, wherein at least one of (i) the capacitor for operating the communication unit is connectable in circuit via at least one of the switch and (ii) the control unit is permanently supplied by the battery.

22. The automation device as claimed in claim 15, wherein the control unit is configured to actuate the switch in a time-controlled or event-controlled manner.

23. The automation device as claimed in claim 15, wherein at least one of (i) the capacitor has a leakage current of up to 3 μA at a temperature of up to 20° C. and (ii) the battery has a capacity of at least 2.0 Ah at a temperature of 55° C., the battery being configured to provide an amperage of at least 20 mA.

24. The automation device as claimed in claim 15, wherein at least one of (i) the switch is configured as a field-effect transistor, (ii) the control unit is configured as a microcontroller and (iii) the communication unit is configured as a radio communication unit.

25. The automation device as claimed in claim 15, wherein the automation device is supplied with electrical energy solely via the energy supply system.

26. The automation device as claimed in claim 15, wherein the application electronics are formed as a measuring apparatus and comprise at least one of (i) a radar emitter, (ii) a lidar emitter or an ultrasonic emitter, (iii) a tuned-diode laser, (iv) a smoke detector and (v) infrared analytics.

27. A method for operating an automation device comprising application electronics, a communication unit and an energy supply system for operating the measuring apparatus, the energy supply system including a battery which is configured as a lithium-thionyl chloride battery, and a capacitor, the battery and the capacitor being interconnected via a switch, the method comprising:
a) placing the automation device into an operating state in which the capacitor is at least partially charged;
b) detecting a temperature and closing the switch in an idle mode of the automation device if the temperature is below a threshold temperature or opening the switch in the idle mode of the automation device if the temperature exceeds the threshold temperature; and
c) closing the switch to support operation of at least one of (i) the communication unit and (ii) the application electronics when the automation device actively operating;
wherein the communication unit is configured as a radio communication unit.

28. The method as claimed in claim 27, wherein the switch is a switch which is actuatable via a control unit of the automation device.

29. The method as claimed in claim 27, wherein step c) is performed in a time-controlled or event-controlled manner.

30. The method as claimed in claim 28, wherein step c) is performed in a time-controlled or event-controlled manner.

31. A control unit for operating an automation device, the control unit comprising:
a memory and a computing unit which are respectively configured to store and execute instructions, the control unit being configured to receive measurement signals and issue control commands;
wherein the control unit is configured to:
a) place an automation device into an operating state in which a capacitor is at least partially charged;
b) detect a temperature and closing a switch in an idle mode of the automation device if the temperature is below a threshold temperature or open the switch in the idle mode of the automation device if the temperature exceeds the threshold temperature; and
c) close the switch to support operation of at least one of (i) the communication unit and (ii) the application electronics when the automation device actively operating;
wherein the communication unit is configured as a radio communication unit.

32. A non-transitory computer program product for simulating an operating behavior of an automation device, comprising at least one digital image of an energy supply system of the automation device, wherein the automation device is configured as claimed in claim 15.
